(19) United States
(12) Patent Application Publication
(10) Pub. No.: US 2010/0058844 A1
(43) Pub. Date: Mar. 11, 2010

(54) Ethanol concentration sensor

(76) Inventors: Yingjie Lin, El Paso, TX (US); Carlos A. Buelna, CD. Juarez (MX); Carlos A. Urquidi, CD. Juarez (MX)

Correspondence Address: Delphi Technologies, Inc., M/C 480-410-202, PO BOX 5052, Troy, MI, 48007, US

(21) Appl. No.: 12/283,326

(22) Filed: Sep. 11, 2008

(51) Int. Cl. G01N 30/62

(52) U.S. Cl. 73/61.61

(57) ABSTRACT

A level of fluid in a container is determined as is a capacitance associated with the fluid. The capacitance and level are used to determine a concentration of ethanol in the fluid.

### FIELD OF THE INVENTION

The present invention relates generally to sensing ethanol concentration in vehicle fuel.

### BACKGROUND OF THE INVENTION

There are various ways to measure the level of a fluid, from the most common floating arm with resistance strip to pressure, capacitive, and ultrasonic methods. The floating arm is the most common method used in the automotive to measure the fuel level, but it has some deficiencies. The connect point of resistive strip is susceptible to contamination and chemical attack, which results in contact problems.

Ethanol use is increasing for a variety of factors, and to ensure proper engine operation, it is important to know the concentration of ethanol in gasoline. The information of ethanol concentration in gasoline is needed for engine control unit (ECU) operation and for EMS self-diagnostic.

### SUMMARY OF THE INVENTION

A level of fluid in a container is determined as is a capacitance associated with the fluid. The capacitance and level are used to determine a concentration of ethanol in the fluid.

In another aspect, a sensor includes a first electrode, first structure associated with the first electrode and together with the first electrode defining first and second capacitances, a second electrode, and second structure associated with the second electrode and together with the second electrode defining third and fourth capacitances. A circuit (which can include a processor such as an ECM) measures the capacitances and adds the capacitances together, with a value including a sum of all four capacitances being correlatable to an ethanol concentration in fluid in which the electrodes are disposable.

In non-limiting embodiments he first structure includes first and second reference electrodes straddling the first electrode while the second structure includes third and fourth reference electrodes straddling the second electrode. The first and second electrodes can be curvilinear, e.g., can be sinusoidal.

The circuit can correlate a ratio of the sum of all four capacitances to fluid level to an ethanol concentration using a lookup data structure.

In another aspect, a sensor includes plural electrodes and a circuit configured to receive signals from the electrodes. The circuit is configured to execute a first operation using the signals to determine a level of fluid in a chamber in which the electrodes can be disposed. Also, the circuit is configured to execute a second operation using the signals to determine an ethanol concentration in the fluid.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an environment in which the present sensor may be used;

FIG. 2 is a plan view of an example electrode configuration;

FIG. 3 is a flow chart of the operation principles;

FIG. 4 is a flow chart of the calibration steps; and

FIGS. 5 and 6 are graphs in accordance with present principles.

### DETAILED DESCRIPTION OF THE PREFERRED EMBODIMENT

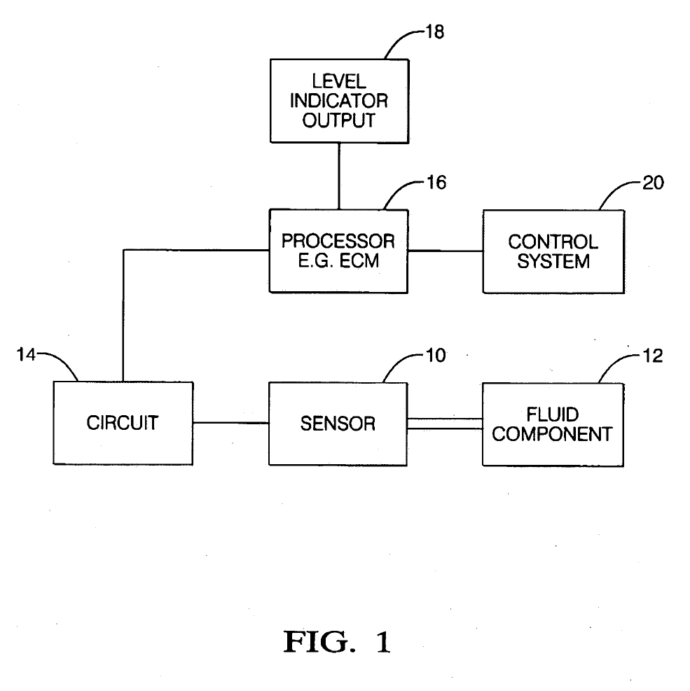

FIG. 1 shows the sensing element configuration of an example sensor 10. The sensor includes at least a first electrode and a second electrode. As set forth further below, a first structure associated with the first electrode defines first and second capacitances, while a second structure associated with the second electrode defines third and fourth capacitances. The sensor 10 is connected to or disposed in a fluid component 12, such as, but not limited to, a gas tank.

In the example embodiment shown, a circuit 14 processes information from the sensor 10 and sends signals to a processor 16, such as an engine control module (ECM). A level and/or concentration indication output 18 is one example source of output information from the processor 16, another being a control system 20 which is controlled in response to signals from the sensor 10. U.S. Pat. No. 6,823,731, incorporated herein by reference, sets forth details of a non-limiting implementation of the sensor 10 that may be used in accordance with present principles.

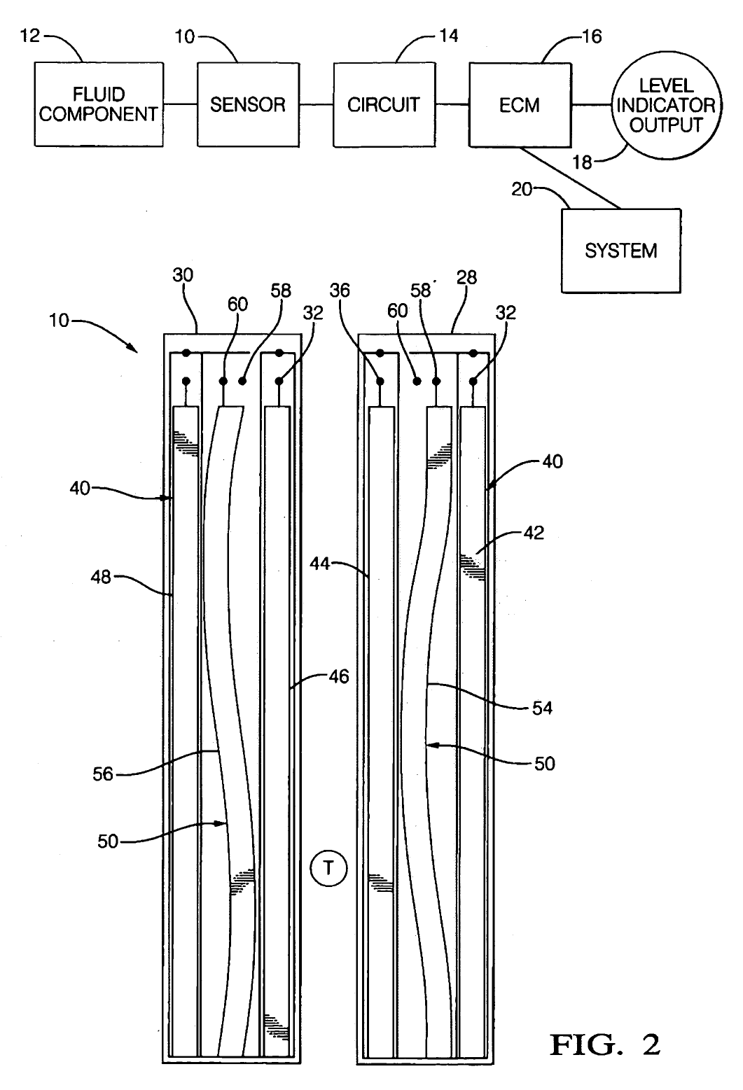

For convenience, referring to FIG. 2, the non-limiting sensing assembly 10 is shown to have first 28 and second 30 substrates. The substrates 28, 30 can be used to mount circuitry (discussed in U.S. Pat. No. 6,823,731) thereto. While only the first 28 and second 30 substrates are shown, it should be appreciated that other substrates may be used. These substrates may extend between the first 28 and second 30 substrates should it be desired to further isolate the circuitry extending along each of the substrates 28, 30.

The non-limiting sensing assembly 10 can include a first input port 32. The first input port 32 can receive a first input voltage signal. The first input port 32 may extend through the substrates 28, 30 allowing circuitry in each of these substrates 28, 30 to receive the first input voltage signal.

The non-limiting sensing assembly 10 also can include a second input port 36 that may extend between the substrates 28, 30. The second input port 36 can receive a second input voltage signal.

A portion of an excitation circuit, generally shown at 40, can be electrically connected to the first 32 and second 36 input ports. The excitation circuit 40 can receive both the first and second input voltage signals. The excitation circuit 40 can generate two excitation signals. A complete discussion of the electrical circuit is set forth in U.S. Pat. No. 6,823,731.

The excitation circuit 40 can include four excitation electrodes 42, 44, 46, 48. The first 42 and third 46 excitation electrodes may receive a first excitation signal, whereas the second 44 and fourth 48 excitation electrodes may receive a second excitation signal. The two excitation signals can be generated by the electrodes 42, 44, 46, 48 when they receive the first and second input voltage signals. More specifically, the first 42 and third 46 excitation electrodes can create a first excitation signal generated through the receipt of the first input voltage signal and the second 44 and fourth 48 excitation electrodes can generate a second excitation signal from the receipt of the second input voltage signal.

The first 42 and second 44 excitation electrodes may extend along the first substrate 28. The third 46 and fourth 48 excitation electrodes may extend along the second substrate 30. The first 42 and third 46 excitation electrodes can be electrically connected to the first input port 32 and the second 44 and fourth 48 excitation electrodes can be electrically connected to the second input port 36.

The non-limiting sensing assembly 10 also can include a receiving circuit, generally shown at 50. The receiving circuit 50 may be disposed adjacent the excitation circuit 40 and, together with the excitation circuit 40, may define a variable capacitance for measuring fluid level in a container in which the assembly 10 is disposed in the upright orientation shown in accordance with U.S. Pat. No. 6,823,731 as well as an additive capacitance in accordance with present principles. The receiving circuit 50 produces output voltage signals that vary with capacitances between the excitation circuit 40 and the receiving circuit 50 which in turn depend on dielectric changes created by the presence or absence of the liquid adjacent the sensing assembly 10.

The receiving circuit 50 can include first 54 and second 56 receiving electrodes. The first receiving electrode 54 may extend between the first 42 and second 44 excitation electrodes. The second receiving electrode 56 may extend between the third 46 and fourth 48 excitation electrodes. Accordingly, the first receiving electrode 54 may extend along the first substrate 28, whereas the second receiving electrode 56 may extend along the second substrate 30. In alternate implementations the roles of the electrodes may be reversed, e.g., the electrode 56 may be an excitation electrode while the electrodes 46, 48 may be receiving electrodes.

The first receiving electrode 54 may extend along a first non-linear path. In the embodiment shown, the first non-linear path is sinusoidal. Likewise, the second receiving electrode 56 may extend along a second non-linear path. The second non-linear path differs from the first non-linear path. Again, in the embodiment shown, the second non-linear path may be sinusoidal and may be out of phase with the first non-linear path. When the second sinusoidal path is out of phase 90 degrees with the first sinusoidal path, the second path describes a cosine.

The first receiving electrode 54 can be electrically connected to a first output port 58 and the second receiving electrode 56 can be electrically connected to a second output port 60. The output voltage signal can be transmitted through the first 58 and second 60 output ports to a control circuit (not shown) for analysis to determine the level of the liquid in accordance with U.S. Pat. No. 6,823,731.

Having described an example sensor that may be used, it may now be appreciated that a capacitance may be measured between each of the following successive pairs of terminals: capacitance “C1” (between output port 60 and input port 36); capacitance “C2” (between output port 60 and input port 32); capacitance “C3” (between output port 58 and input port 36); and capacitance “C4” (between output port 58 and input port 32).

A temperature sensor “T” may also be included to output a signal representative of the temperature of the fluid for purposes to be shortly disclosed.

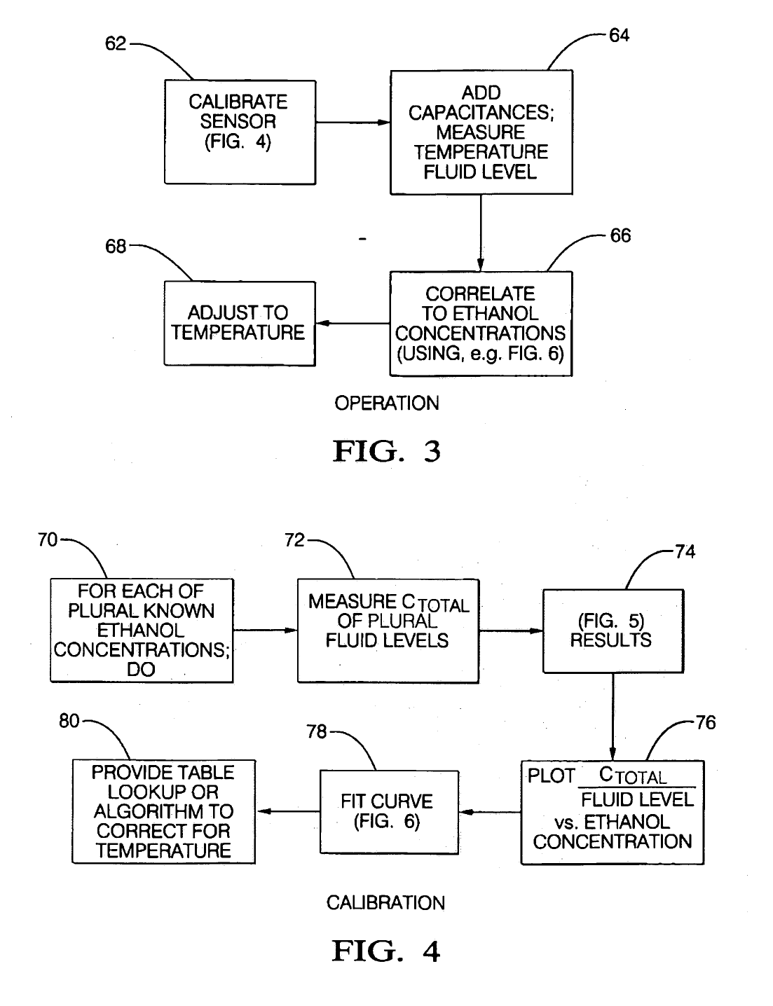

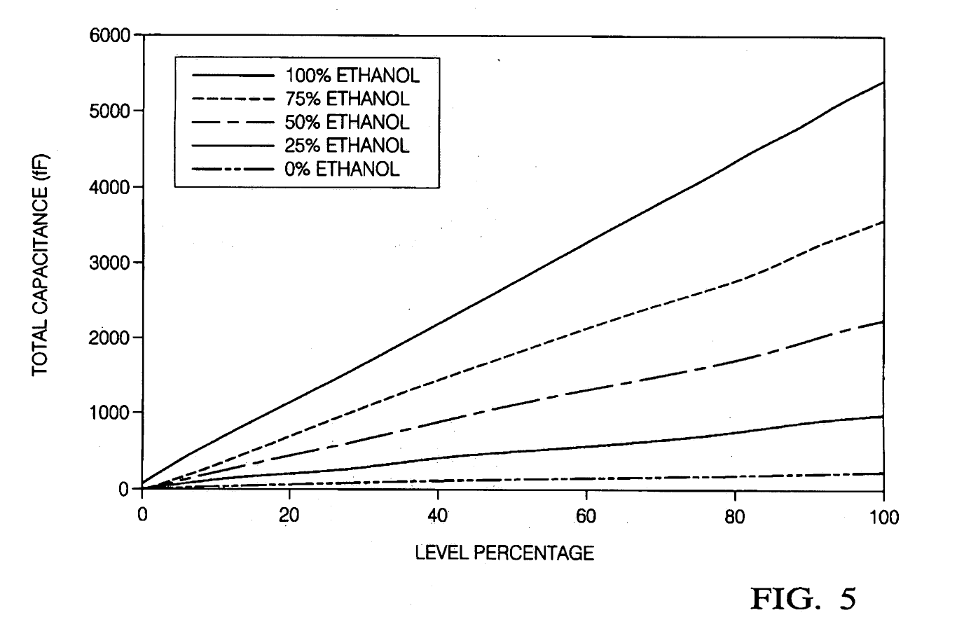

Moving to FIG. 3 in the form of a flow chart, the operation of the sensor and its associated circuits is shown. Here, the relation between the slope of the total capacitance and the ethanol concentration is described. At block 62, the sensor is first calibrated, as further detailed by FIG. 4.

At block 64, the four capacitances (equivalently, voltages representative thereof) described above are sensed and added together, the fluid level is determined in accordance with the above-referenced patent, and the temperature is measured in order to compensate the slope value as described further below. The total capacitance is obtained through this addition of the four capacitances.

In the example shown, the ethanol concentration may be obtained at block 66 by using FIG. 6. The ratio of the total capacitance to fluid level is obtained and the corresponding ethanol concentration from the curve picked off to establish an initial ethanol concentration. Lastly, the initial ethanol concentration may be adjusted for temperature at block 68 as described further below.

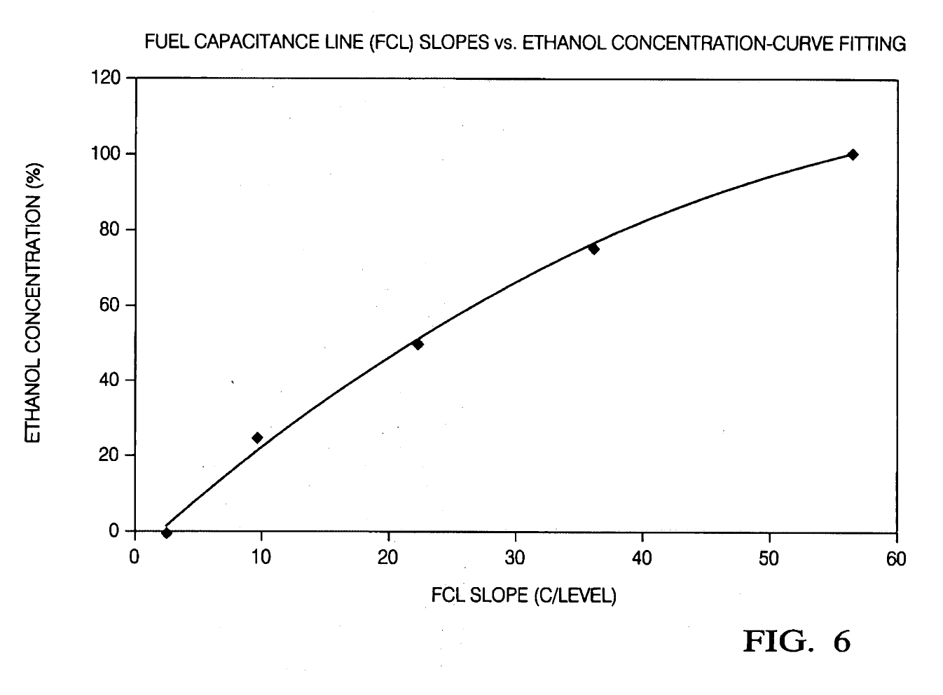

As mentioned above, FIG. 4 describes the sensor calibration process in the form of a flow chart. At block 70, for each of plural known ethanol concentrations, the following blocks 72-80 are carried out. The total capacitance at plural fluid levels is measured and calculated at block 72. When the data points for the plural known concentrations are obtained, they can be plotted to arrive at FIG. 5. It has been found that there is a linear relationship between ethanol concentration and total capacitance, allowing for a fairly simple and accurate correlation from one to the other.

At block 76, the total capacitance over fluid level obtained from FIG. 5 is then plotted against the ethanol concentration to establish a series of points as shown in FIG. 6. Then at block 78, the curve shown in FIG. 6 it fitted to the points using curve fitting techniques known in the art.

The calibration above typically is executed at a single known temperature, e.g., room temperature. As understood herein, the capacitance of the fluid may change with temperature. Accordingly, at block 80, an algorithm or table lookup is generated for use in correcting the ethanol concentration found using FIG. 6 for temperature. As one non-limiting example, the capacitance of each of plural test fluids with known ethanol concentrations may be measured at different temperatures and plotted. Subsequently, the plot may be accessed and the curve with the closest ethanol concentration to the concentration measured at block 66 selected. The corrected capacitance value is represented by the y-axis value on the curve that corresponds to the x-axis value of the curve representing the actual temperature measured at block 64. This corrected capacitance value may then be used as a new total capacitance value to determine a temperature-corrected ethanol concentration using above principles.

While the particular ETHANOL CONCENTRATION SENSOR is herein shown and described in detail, it is to be understood that the subject matter which is encompassed by the present invention is limited only by the claims.

What is claimed is:

1. Sensor, comprising:
at least a first sensing electrode;
first structure associated with the first sensing electrode and together with the first electrode defining first and second capacitances;
at least a second sensing electrode;
second structure associated with the second sensing electrode and together with the second sensing electrode defining third and fourth capacitances; and
circuit measuring the capacitances and adding the capacitances together, a value including a sum of all four capacitances being correlatable to an ethanol concentration in fluid in which the electrodes are disposable.

2. Sensor of claim 1, wherein the first structure includes first and second reference electrodes straddling the first sensing electrode.

3. Sensor of claim 1, wherein the second structure includes third and fourth reference electrodes straddling the second sensing electrode.

4. Sensor of claim 1, wherein the sensing electrodes are curvilinear.

5. Sensor of claim 4, wherein the sensing electrodes are sinusoidal.

6. Sensor of claim 5, wherein the first sensing electrode defines a sine shape and the second sensing electrode defines a cosine shape.

7. Sensor of claim 1, wherein the circuit correlates a ratio of the sum of all four capacitances to fluid level to an ethanol concentration using a lookup data structure.

8. Sensor comprising:
plural electrodes;
circuit configured to receive signals from the electrodes, the circuit configured to execute a first operation using the signals to determine a level of fluid in a chamber in which the electrodes can be disposed, the circuit configured to execute a second operation using the signals to determine an ethanol concentration in the fluid.

9. The sensor of claim 8, wherein the signals at least in part represent capacitances.

10. The sensor of claim 8, wherein the electrodes are not linear.

11. The sensor of claim 8, wherein the electrodes are sinusoidal.

12. Method, comprising:
determining a level of fluid in a container;
determining a capacitance associated with the fluid; and
using the capacitance and level, determining a concentration of ethanol in the fluid.

13. The method of claim 12, wherein the measuring acts both use a common sensor.

14. The method of claim 12, comprising measuring a temperature of the fluid and correcting the concentration based thereon.

15. The method of claim 12, wherein the capacitance represents a sum of capacitances.

16. The method of claim 15, wherein the sum of capacitances is equal to C1 plus C2 plus C3 plus C4, wherein C1 is a capacitance between a first non-linear electrode and a first reference electrode, C2 is a capacitance between the first non-linear electrode and a second reference electrode, C3 is a capacitance between a second non-linear electrode and a third reference electrode, and C4 is a capacitance between the second non-linear electrode and a fourth reference electrode.
